(19) United States
(12) Patent Application Publication
(10) Pub. No.: US 2016/0028666 A1
(43) Pub. Date: Jan. 28, 2016

(54) SYSTEM AND METHOD FOR INSTANT MESSAGING

(71) Applicant: FRAMY INC., GRAND CAYMAN (KY)

(72) Inventor: YU-HSIEN LI, TAIPEI (TW)

(21) Appl. No.: 14/339,823

(22) Filed: Jul. 24, 2014

(51) Int. Cl. H04L 12/58; G06F 3/0484; G06F 3/0482

(52) U.S. Cl. CPC H04L 51/046; G06F 3/0482; G06F 3/04842; H04L 51/10

(57) ABSTRACT

A method of instant messaging is provides. The method comprises providing an image frame for display of a message in an event of instant messaging, the image frame configured to exhibit a textual input, a background environment and a character associated with the message; receiving at least one of a textual input, a background environment or a character from a user; and integrating into the image frame the received at least one of the textual input, the background environment or the character.

### BACKGROUND

The popularity of the Internet has experienced an exponential growth in the past decade. As the bandwidth of the Internet becomes broader, transmission of information and electronic data over the Internet becomes faster. With the development of the network technology, instant messaging (IM), which makes the contacts and communications among people more and more convenient, is increasingly recognized and accepted by users.

As an instant contact way among people through the Internet, instant messaging has the characteristics of strong interactivity and low cost so as to be widely popularized in a relatively short time. However, instant messaging systems are limited in their functionality. For example, in some existing instant messaging systems, a message is provided in the form of text displayed in a speech pane or balloon. Often, a user's thought or opinion may not be complete or become fully understandable in one speech pane. As such, more than one speech panes are required to express the user's thought or opinion. Meanwhile, during the instant messaging session, other user may also share their thoughts or opinions in intervening speech panes. Consequently, the first user's speech panes become shattered and are not arranged in good order. Furthermore, although words can convey a user's thought or emotion, people in the Internet world realize that an image (such as a sticker, a photo or even a film) may speak louder than words. As a result, a user may choose to share his/her thought or emotion through image. In some existing instant messaging systems, however, a user may need to send text and image in separate messages, and thus may suffer the issue of intervening panes. Ways to improve expression of feelings, thoughts or emotions for instant messaging are continuingly being sought.

### BRIEF DESCRIPTION OF THE DRAWINGS

One or more embodiments are illustrated by way of example and, not by limitation, in the figures of the accompanying drawings, elements having the same reference numeral designations represent like elements throughout. The drawings are not drawn to scale, unless otherwise disclosed.

FIG. 1 is a schematic view of an instant messaging system, in accordance with some embodiments of the present disclosure.

FIG. 2 is a diagram illustrating a message at display at the instant messaging system, in accordance with some embodiments of the present disclosure.

FIG. 3 is a flow diagram illustrating a method of instant messaging, in accordance with some embodiments of the present disclosure.

FIGS. 4A to 4C are diagrams illustrating exemplary textual inputs at the instant messaging system.

FIG. 4D is a diagram illustrating an animated content of a textual input at the instant messaging system, in accordance with some embodiments of the present disclosure.

FIGS. 5A and 5B are diagrams illustrating exemplary textual inputs at the instant messaging system.

FIGS. 6A to 6C are diagrams illustrating exemplary background environments at the instant messaging system.

FIG. 6D is a diagram illustrating an animated content of a background environment at the instant messaging system, in accordance with some embodiments of the present disclosure.

FIGS. 7A to 7C are diagrams illustrating exemplary characters at the instant messaging system.

FIG. 7D is a set of diagrams illustrating an animated content of a character at the instant messaging system, in accordance with some embodiments of the present disclosure.

FIG. 8 is a set of diagrams illustrating an animated content including texts and a background environment at the instant messaging system, in accordance with some embodiments of the present disclosure.

FIG. 9 is a set of diagrams illustrating an animated content including texts, a background environment and a character at the instant messaging system, in accordance with some embodiments of the present disclosure.

FIG. 10 is a set of diagrams illustrating an exemplary animated content at the instant messaging system.

FIG. 11 is a set of diagrams illustrating another exemplary animated content at the instant messaging system.

FIG. 12 is a set of diagrams illustrating still another exemplary animated content at the instant messaging system.

FIG. 13 is a set of diagrams illustrating yet still another exemplary animated content at the instant messaging system.

FIGS. 14A and 14B are diagrams illustrating an animated content in separate image frames at the instant messaging system, in accordance with some embodiments of the present disclosure.

FIGS. 15A and 15B are diagrams illustrating an animated content in separate image frames at the instant messaging system, in accordance with some embodiments of the present disclosure.

FIG. 16 is a flow diagram illustrating a method of instant messaging, in accordance with some embodiments of the present disclosure.

Like reference symbols in the various drawings indicate like elements.

### DETAILED DESCRIPTION OF THE DISCLOSURE

The following disclosure provides many different embodiments, or examples, for implementing different features of the provided subject matter. Any alterations and modifications in the described embodiments, and any further applications of principles described in this document are contemplated as would normally occur to one of ordinary skill in the art to which the disclosure relates. Specific examples of components and arrangements are described below to simplify the present disclosure. These are, of course, merely examples and are not intended to be limiting. For example, when an element is referred to as being “connected to” or “coupled to” another element, it may be directly connected to or coupled to the other element, or intervening elements may be present.

Throughout the various views and illustrative embodiments, like reference numerals and/or letters are used to designate like elements. Reference will now be made in detail to exemplary embodiments illustrated in the accompanying drawings. Wherever possible, the same reference numbers are used in the drawings and the description to refer to the same or like parts. Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments. It should be appreciated that the following figures are not drawn to scale; rather, these figures are merely intended for illustration.

It will be understood that singular forms “a”, “an” and “the” are intended to include the plural forms as well, unless the context clearly indicates otherwise. Furthermore, relative terms, such as “bottom” and “top,” may be used herein to describe one element's relationship to other elements as illustrated in the Figures.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

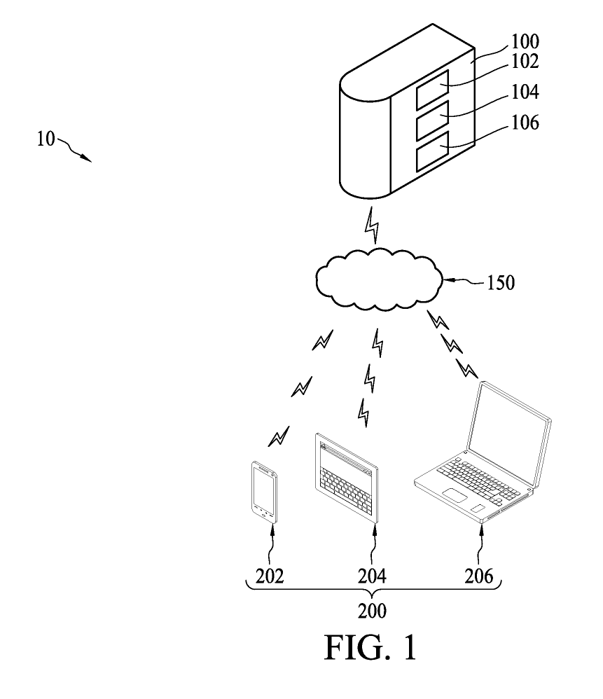

FIG. 1 is a schematic of an instant messaging system 10, in accordance with some embodiments of the present disclosure.

Referring to FIG. 1, the instant messaging system 10 includes an internet server 100 equipped with one or more processing units 102, a memory 104, and an I/O port 106. The processing unit 102, the memory 104, and the I/O port 106 are electrically connected with each other. Accordingly, electrical signals and instructions can be transmitted there-between. In addition, the I/O port 106 is configured as an interface between the internet server 100 and any external device. Therefore, electrical signals can be received or transmitted by the internet server 100 via the I/O port 106.

In some embodiments in accordance with the present disclosure, the processing unit 102 is a central processing unit (CPU) or part of a computing module. The processing unit 102 is configured to execute one or more programs stored in the memory 104. Accordingly, the processing unit 102 is configured to enable the internet server 100 to perform specific operations disclosed herein. It is to be noted that the operations and techniques described herein may be implemented, at least in part, in hardware, software, firmware, or any combination thereof. For example, various aspects of the described embodiments may be implemented within one or more processing units, including one or more microprocessing units, digital signal processing units (DSPs), application specific integrated circuits (ASICs), field programmable gate arrays (FPGAs), or any other equivalent integrated or discrete logic circuitry, as well as any combinations of such components. The term “processing unit” or “processing circuitry” may generally refer to any of the foregoing logic circuitry, alone or in combination with other logic circuitry, or any other equivalent circuitry. A control unit including hardware may also perform one or more of the techniques of the present disclosure.

In some embodiments in accordance with the present disclosure, the memory 104 includes any computer readable medium, including, but not limited to, a random access memory (RAM), read only memory (ROM), programmable read only memory (PROM), erasable programmable read only memory (EPROM), electronically erasable programmable read only memory (EEPROM), flash memory, a hard disk, a solid state drive (SSD), a compact disc ROM (CD-ROM), a floppy disk, a cassette, magnetic media, optical media, or other computer readable media. In an embodiment, the memory 104 is incorporated into the processing unit 102.

In some embodiments in accordance with the present disclosure, the internet server 100 is configured to utilize the I/O port 106 communicate with external devices via a network 150, such as a wireless network. In certain embodiments, the I/O port 106 is a network interface component, such as an Ethernet card, an optical transceiver, a radio frequency transceiver, or any other type of device that can send and receive data from the Internet. Examples of network interfaces may include Bluetooth®, 3G and WiFi® radios in mobile computing devices as well as USB. Examples of wireless networks may include WiFi®, Bluetooth®, and 3G. In some embodiments, the internet server 100 is configured to utilize the I/O port 106 to wirelessly communicate with a client device 200, such as a mobile phone 202, a tablet PC 204, a portable laptop 206 or any other computing device with internet connectivity. Accordingly, electrical signals are transmitted between the internet server 100 and the client device 200.

In some embodiments in accordance with the present disclosure, the internet server 100 is a virtual server capable of performing any function a regular server has. In certain embodiments, the internet server 100 is another client device of the social networking system 100. In other words, there may not be a centralized host for the instant messaging system 10, and the client devices 200 in the instant messaging system 10 are configured to communicate with each other directly. In certain embodiments, such client devices communicate with each other on a peer-to-peer (P2P) basis.

In some embodiments in accordance with the present disclosure, the client device 200 may include one or more batteries or power sources, which may be rechargeable and provide power to the client device 200. One or more power sources may include a battery made from nickel-cadmium, lithium-ion, or any other suitable material. In certain embodiments, the one or more power sources may be rechargeable and/or the client device 200 can be powered via a power supply connection.

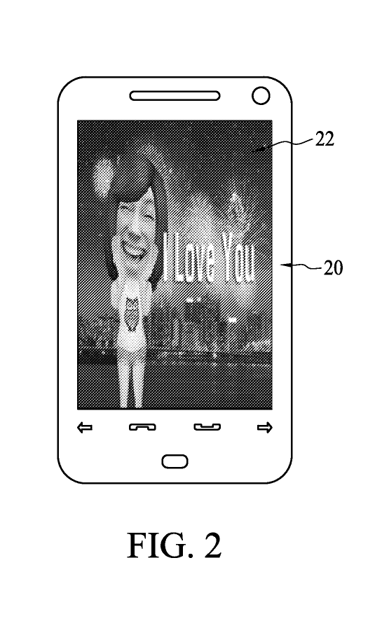

FIG. 2 is a diagram illustrating a message 20 at display at the instant messaging system, in accordance with some embodiments of the present disclosure. Referring to FIG. 2, the message 20 includes a textual input (I Love You), a background environment (a harbor city's fireworks show), and a character (a young girl who blushed at the thought of saying I love you). Unlike some existing approaches, the instant messaging system 10 according to the embodiments of the present disclosure integrates texts, a background environment and a character in a same message, and displays the message 20 in an image frame 22. Effectively, a user's thought or emotion can be more actually, vividly and comprehensively expressed. In the current embodiment, the message 20 includes a still image. Nevertheless, in some embodiments, the message 20 includes a motion image or animated content. Moreover, as will be further discussed, in some embodiments, at least one of the texts, background environment or character includes a still image. Furthermore, in other embodiments, at least one of the texts, background environment or character includes an animated content.

Details of the background environment and character have been discussed in U.S. Utility patent application Ser. No. 14/200,137 (hereinafter the '137 application), filed on Mar. 7, 2014 and entitled “METHOD AND SYSTEM FOR MODELING EMOTION,” U.S. Utility patent application Ser. No. 14/200,120 (hereinafter the '120 application), filed on Mar. 7, 2014 and entitled “SYSTEM AND METHOD FOR GENERATING ANIMATED CONTENT,” and U.S. Utility patent application Ser. No. 14/319,279 (hereinafter the '279 application), filed on Jun. 30, 2014 and entitled “METHOD AND SYSTEM FOR GENERATING ANIMATED CONTENT,” which is a continuation-in-part application of the '137 and '120 applications. Moreover, hardware structures and software configurations for performing or executing the features of character and background environment have also been discussed in the '137, '120 and '279 applications. These applications are incorporated herein by reference in their entirety.

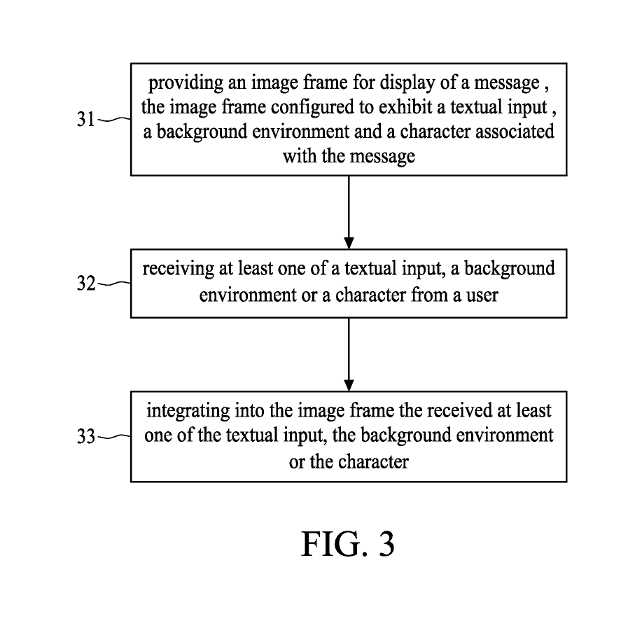

FIG. 3 is a flow diagram illustrating a method of instant messaging, in accordance with some embodiments of the present disclosure. Referring to FIG. 3, in operation 31, an image frame for display of a message is provided. The image frame is configured to exhibit a textual input, a background environment and a character associated with the message. In some embodiments, the image frame is accessible to a client device or user equipment by downloading programs from the server 100 or executing programs stored in a non-volatile, computer readable storage medium. Effectively, the image frame facilitates interaction among users of client devices via the server 100.

In operation 32, at least one of a textual input, a background environment or a character is received from a user. While supporting display of texts, background environment and character at the same time, a message, as so determined by the user, may include texts, background environment or character alone or a limited combination thereof. In an embodiment, the instant messaging system 10 provides a set of default background environments, from which the user may select one for use in the image frame. In another embodiment, the instant messaging system 10 provides a set of default body figures, from which the user may select one for use in the image frame. Moreover, in some embodiments, a new user is required to provide one or more headshot photos to the instant messaging system 10. In other embodiments, the instant messaging system 10 provides a set of default headshot photos, from which a user may select on or more of them for use in the image frame. The instant messaging system 10 is configured to attach one of the headshot photos to a selected body figure to form a character, and change a headshot photo attached to the selected body figure to another one of the headshot photos.

In operation 33, the received at least one of the textual input, the background environment or the character is integrated into the image frame. As a result, a message that integrates the textual input, background environment and character is achieved. A first user may then send the message to a second user in the instant messaging system. The second user may reply a message prepared in a similar fashion to the first user. The texts, background environment and character, integrated in one image frame, can be sent in a single message, which would otherwise be sent in separate messages in some existing approaches. As a result, the method according to the present disclosure makes instant messaging more seamless and instantaneous than such existing approaches.

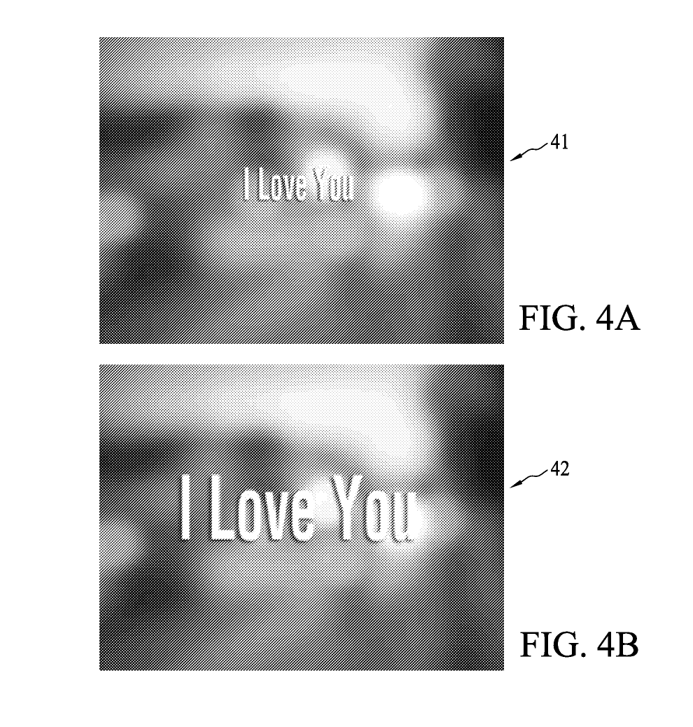

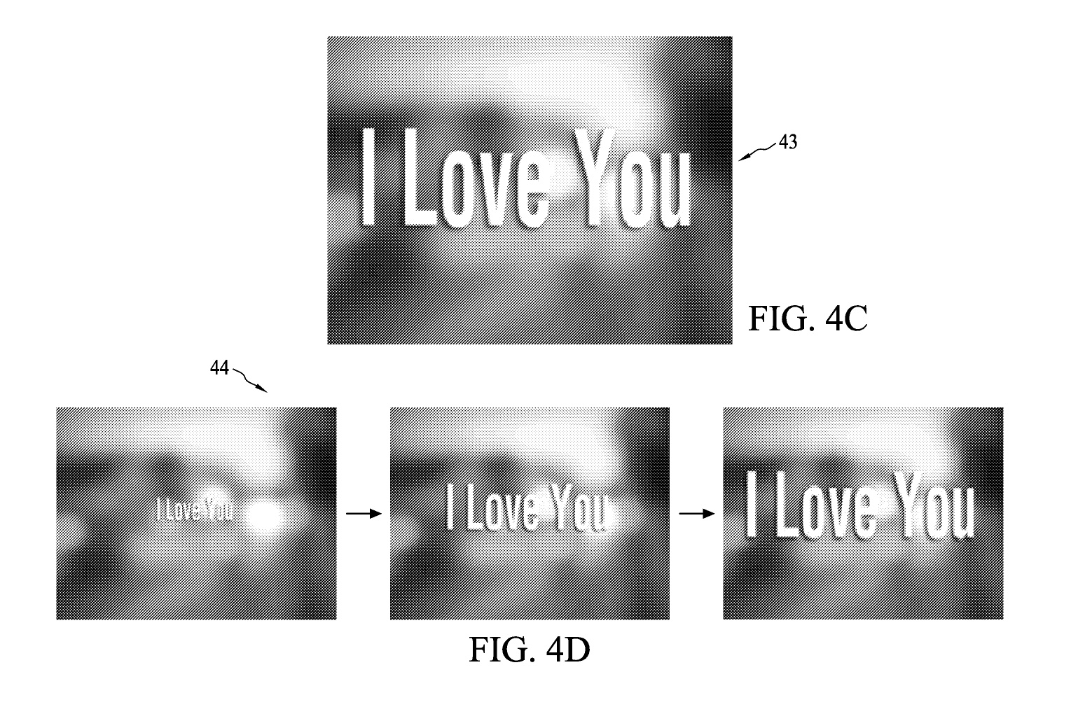

FIGS. 4A to 4C are diagrams illustrating exemplary textual inputs at the instant messaging system. FIG. 4A shows a first message 41 including texts “I Love You” of a first font size in a background environment. The texts are entered by a user using a client device. In the first message 41, the texts and background environment are motionless and no character is present.

FIG. 4B shows a second message 42 including texts “I Love You” of a second font size. The second message 42 is similar to the first message 41 except that the second font size is greater than the first font size. In an embodiment, texts in an image frame can be resized by a user by tapping on and then stretching or shrinking the texts by fingers.

FIG. 4C shows a third message 43 including texts “I Love You” of a third font size. The third message 43 is similar to the second message 42 except that the third font size is greater than the second font size.

FIG. 4D is a diagram illustrating an animated content of a textual input at the instant messaging system, in accordance with some embodiments of the present disclosure. Referring to FIG. 4D, a message 44 includes an animated content of the texts “I Love You” in different font sizes. In the present embodiment, the contents of messages 41, 42 and 43, which are motionless, are integrated into the message 44 and the texts of different font sizes are demonstrated as an animation in the message 44. In an embodiment, the texts of different font sizes are displayed in a predetermined order in the message 44. In another embodiment, the texts of different font sizes are displayed in an arbitrary order in the message 44.

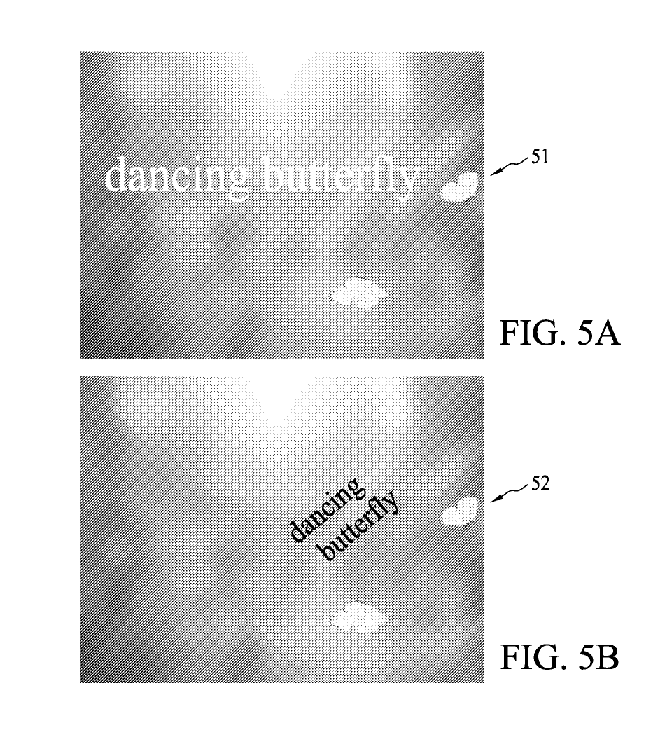

FIGS. 5A and 5B are diagrams illustrating exemplary textual inputs at the instant messaging system. FIG. 5A shows a first message 51 including texts “dancing butterfly” in a background environment. FIG. 5B shows a second message 52 also having the texts, “dancing butterfly,” in the same background environment. However, the texts in the second message 52 are different from those in the first message 51 in font, size, position, orientation, color and pattern. In an embodiment, texts in an image frame can be reorganized by a user so that the reorganized texts are different from the texts in at least one of font, size, position, orientation, color and pattern, as in the case of the first message 51 and the second message 52. In another embodiment, an art effect can be added to texts. For example, the word “dancing” in the texts “dancing butterfly” is fluttering. For another example, the word “butterfly” is changing from one color to another. In some embodiments, the contents of the first message 51 and the second message 52 are integrated in an animated content, as in the case of message 44 described and illustrated in FIG. 4D. In some embodiments, the first message 51 or the second message 52 is composed of texts and free from any background environments or characters.

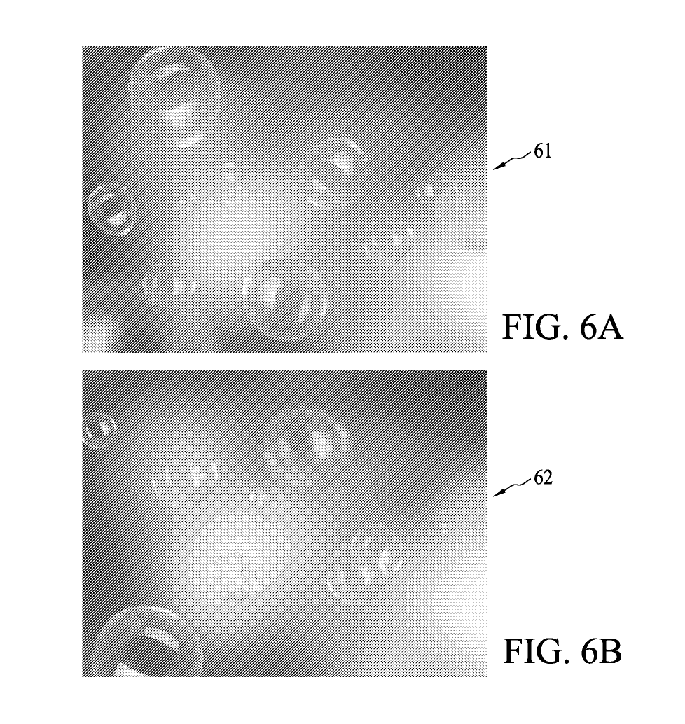

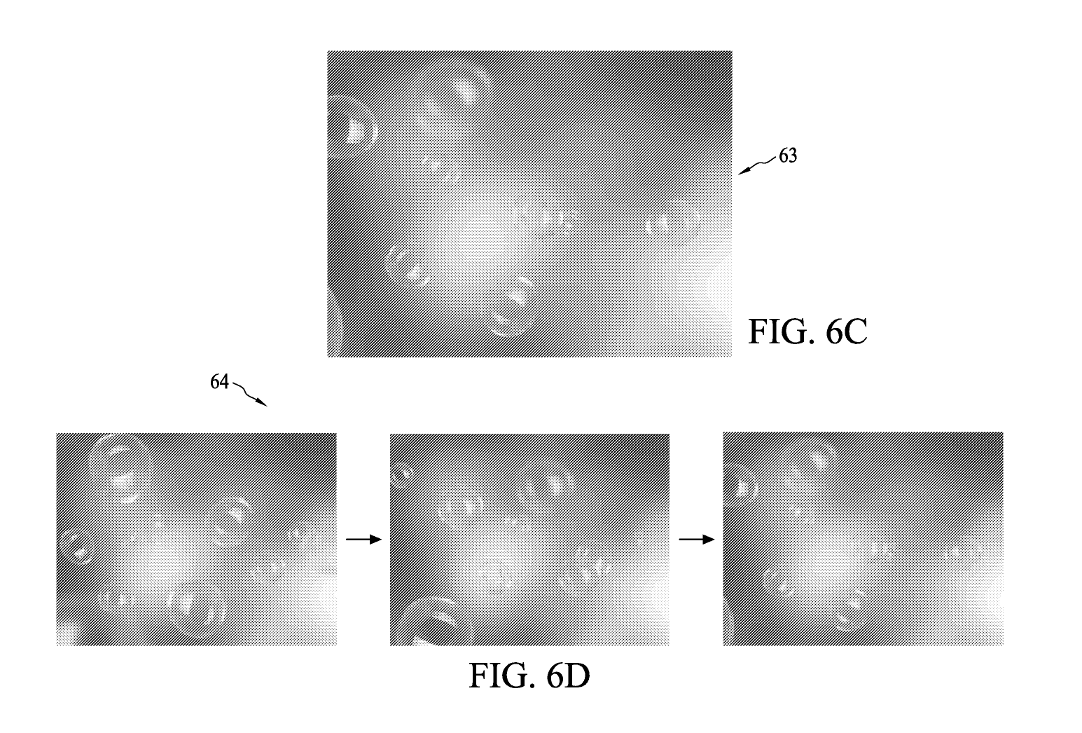

FIGS. 6A to 6C are diagrams illustrating exemplary background environments at the instant messaging system. Messages 61, 62 and 63 illustrated in FIGS. 6A, 6B and 6C, respectively, are composed of background environments and free from any texts or characters.

FIG. 6D is a diagram illustrating an animated content of a background environment at the instant messaging system, in accordance with some embodiments of the present disclosure. Referring to FIG. 6D, a message 44 includes an animated content of background environments having different bubble patterns. In the present embodiment, the contents of messages 61, 62 and 63, which are motionless, are integrated into the message 64 and bubble patterns are demonstrated as an animation in the message 64.

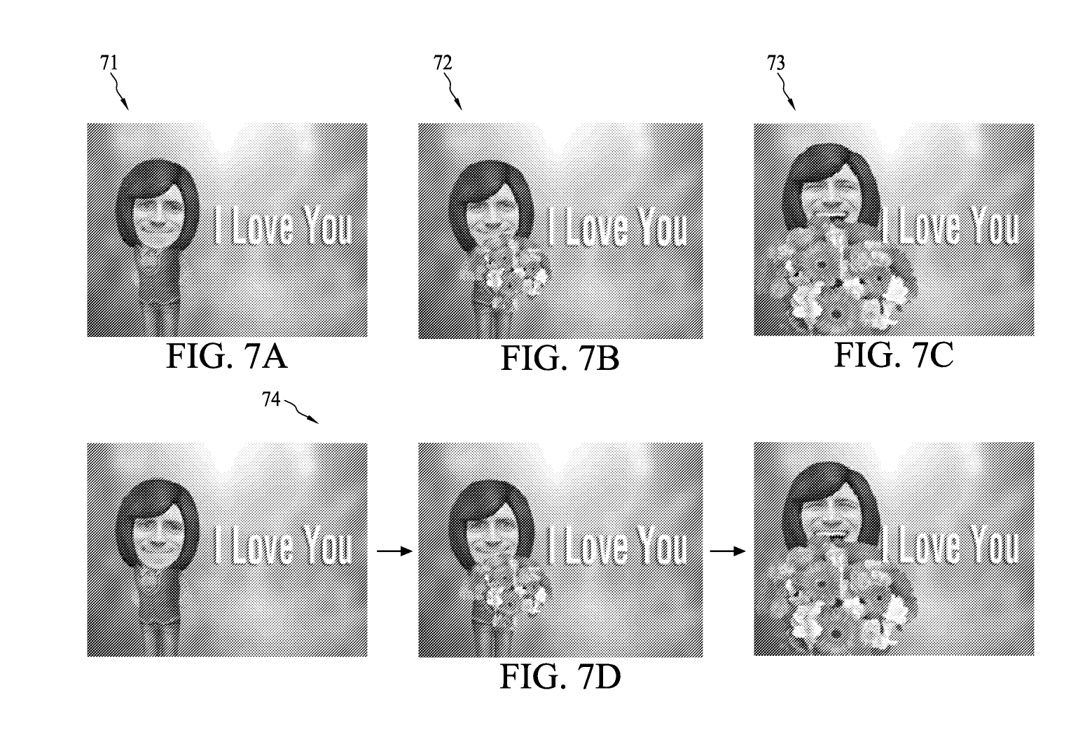

FIGS. 7A to 7C are diagrams illustrating exemplary characters at the instant messaging system. Messages 71, 72 and 73 illustrated in FIGS. 7A, 7B and 7C, respectively, include texts, a background environment and a character. Referring to FIG. 7A, in the first message 71, the character (lets call him Romeo) looks like hiding something behind and is about to give a surprise to the viewer of the first message 71. In FIG. 7B, Romeo shows a bouquet of flower in the second message 72. Referring to FIG. 7C, Romeo comes approaching and presents the bouquet of flower to the viewer in the third message 73. Romeo's facial expression changes from staring amorously in FIGS. 7A and 7B to laughing whole-heartedly in FIG. 7C.

FIG. 7D is a set of diagrams illustrating an animated content of a character at the instant messaging system, in accordance with some embodiments of the present disclosure. Referring to FIG. 7D, a message 74 includes an animated content of the character Romeo. In the present embodiment, the contents of messages 71, 72 and 73, which are motionless, are integrated into the message 74 and Romeo's performance is demonstrated as an animation in the message 74.

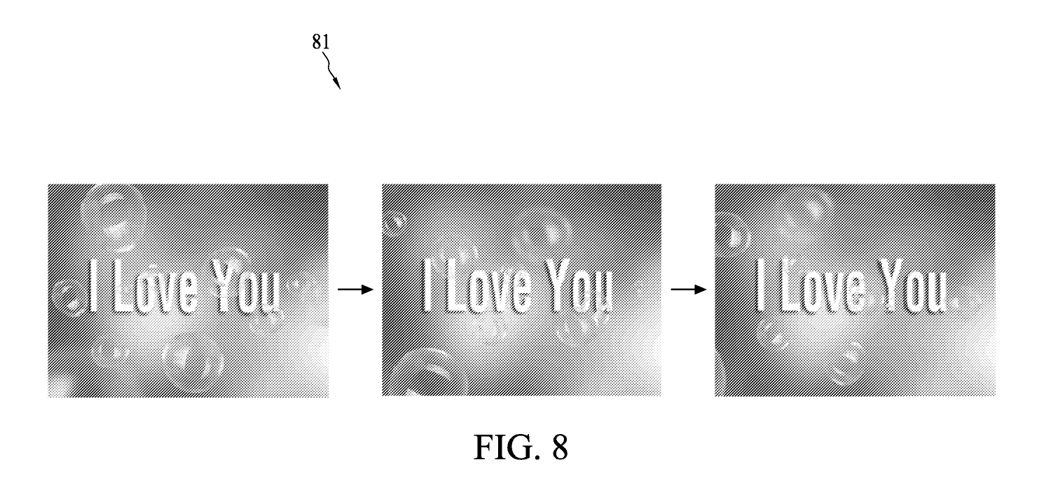

FIG. 8 is a set of diagrams illustrating an animated content including texts and a background environment at the instant messaging system, in accordance with some embodiments of the present disclosure. Referring to FIG. 8, in message 81, the animated content includes a smoothly changing background environment, showing bubbles drifting gently and aimlessly. The message 81 can implicitly express a user's peaceful thought or emotion.

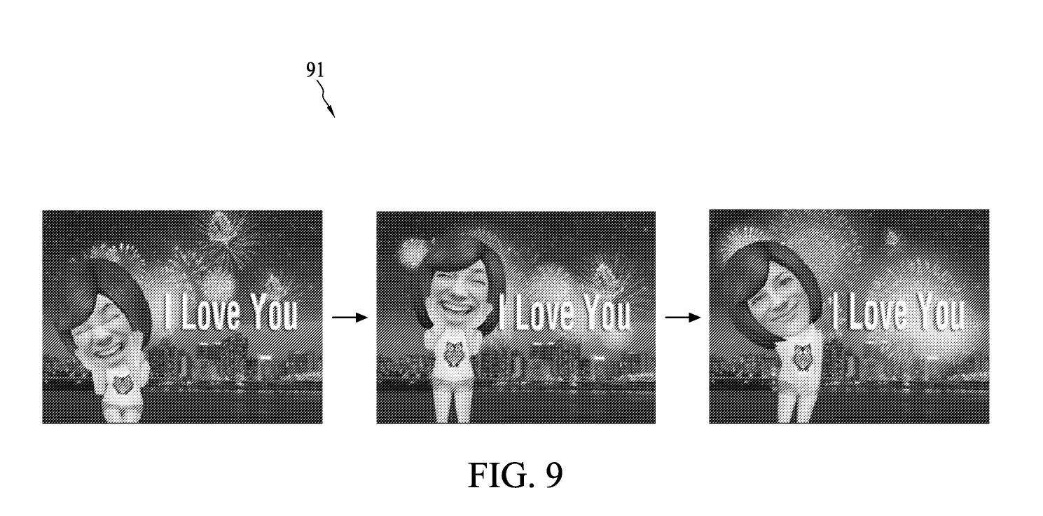

FIG. 9 is a set of diagrams illustrating an animated content including texts, a background environment and a character at the instant messaging system, in accordance with some embodiments of the present disclosure. Referring to FIG. 9, in message 91, the animated content includes a dynamically changing background environment, showing a big firework display. The message 91 can vividly express a user's strong emotion or feeling. In message 91, the character (let's call her Juliet) smiles shyly to say “I Love You” towards the viewer. A series of change in Juliet's facial expression only makes the message 91 more interesting.

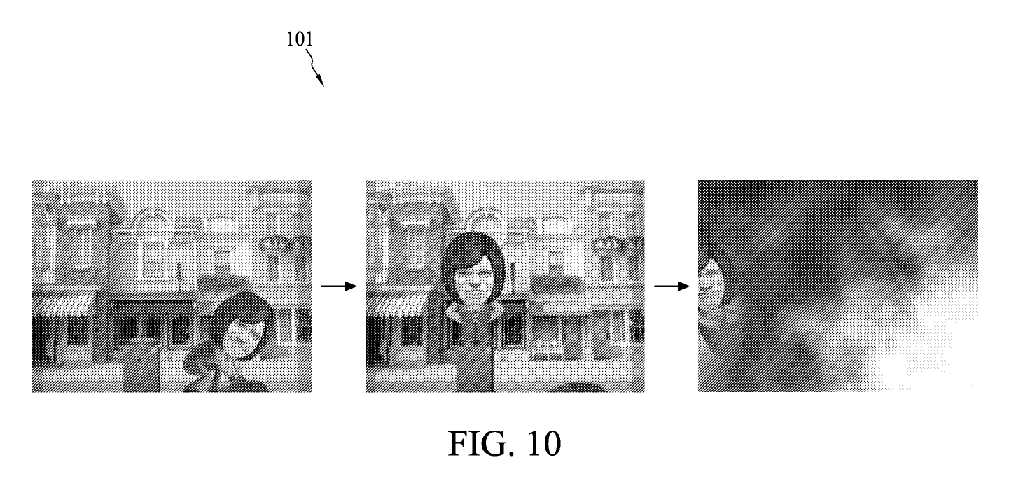

FIG. 10 is a set of diagrams illustrating an exemplary animated content at the instant messaging system. Referring to FIG. 10, a message 101 includes three sub-frames to show that Romeo sets up dynamite, sets of the dynamite and causes a big explosion. In some embodiments, the sub-frame of the big explosion in the animated content has a longer display time than the other sub-frames.

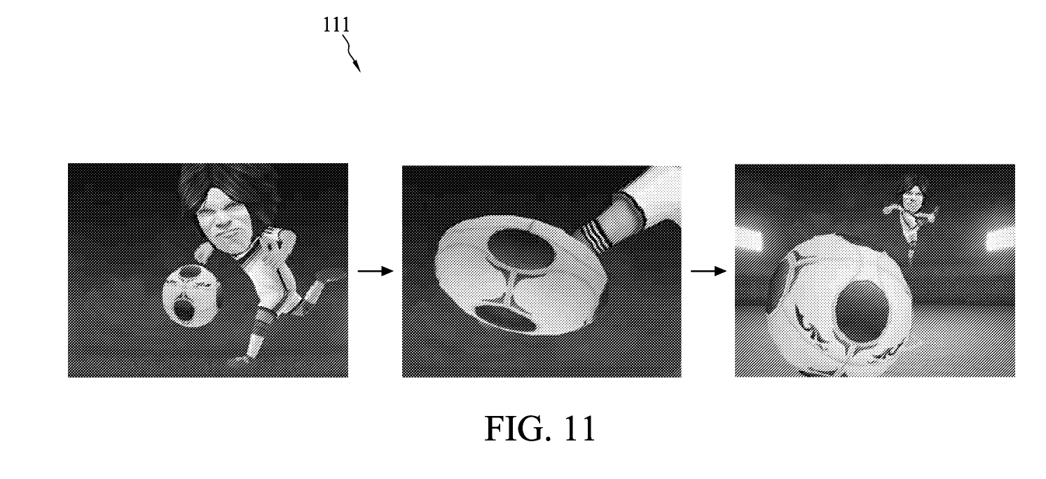

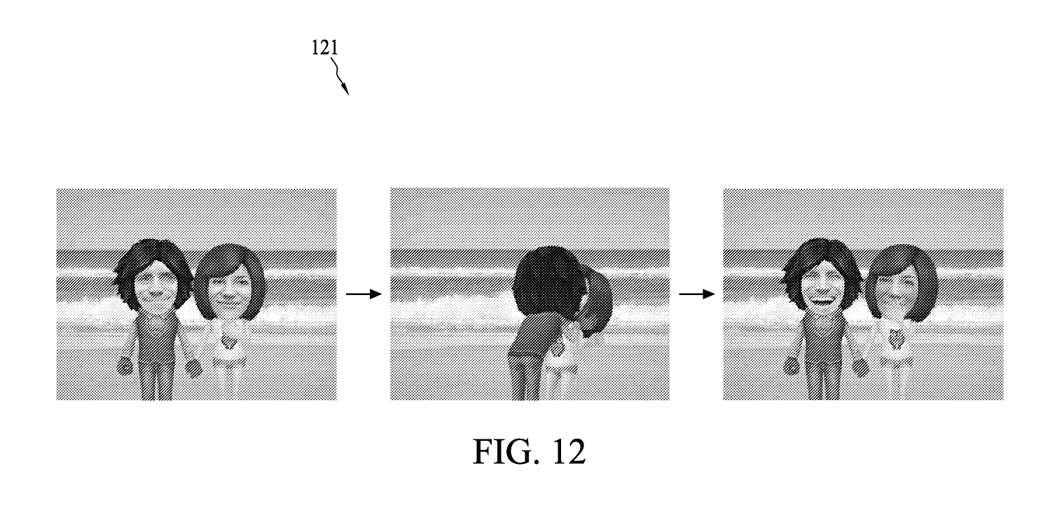

FIG. 11 is a set of diagrams illustrating another exemplary animated content at the instant messaging system. Referring to FIG. 11, a message 111 includes three sub-frames to show that Romeo chases after a ball, kicks the ball and goals. In an embodiment, the sub-frame of kicking the ball in the animated content is displayed in slow motion. In another embodiment, the sub-frame of chasing after the ball in the animated content is displayed in fast motion. In still another embodiment, the sub-frame of scoring a goal in the animated content is displayed for a longer time than the other sub-frames.

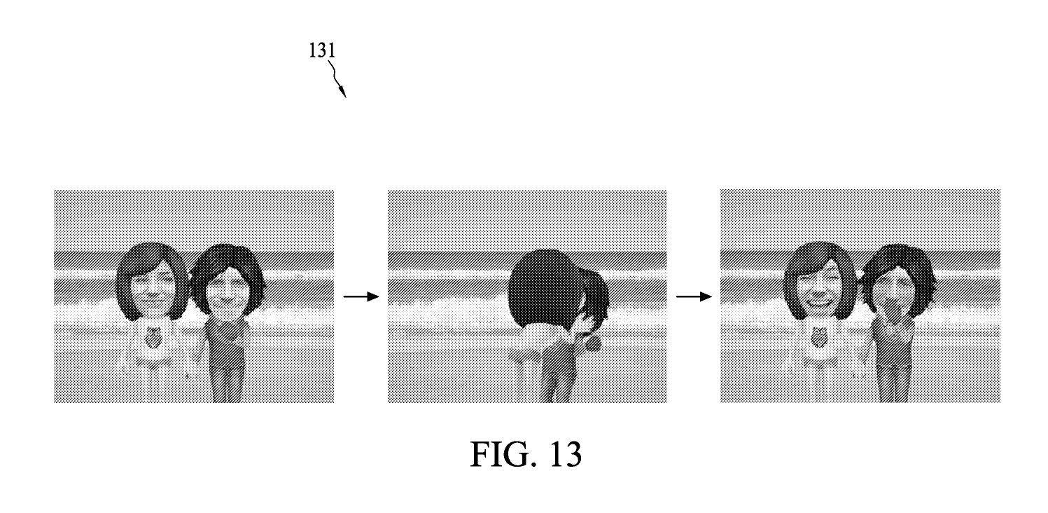

FIG. 12 is a set of diagrams illustrating still another exemplary animated content at the instant messaging system. Referring to FIG. 12, in message 121, two characters are present. The message 121 includes three sub-frames, showing that Romeo and Juliet hand in hand stroll along a beach, Romeo suddenly kisses Juliet, and Juliet blushes. How romantic! The scenario can be completely changed by swapping the position of Romeo and Juliet, as illustrated in FIG. 13.

FIG. 13 is a set of diagrams illustrating yet still another exemplary animated content at the instant messaging system. Referring to FIG. 13, in message 131, Juliet and Romeo hand in hand stroll along the same beach, Juliet suddenly kisses Romeo, and Romeo blushes. How touching!

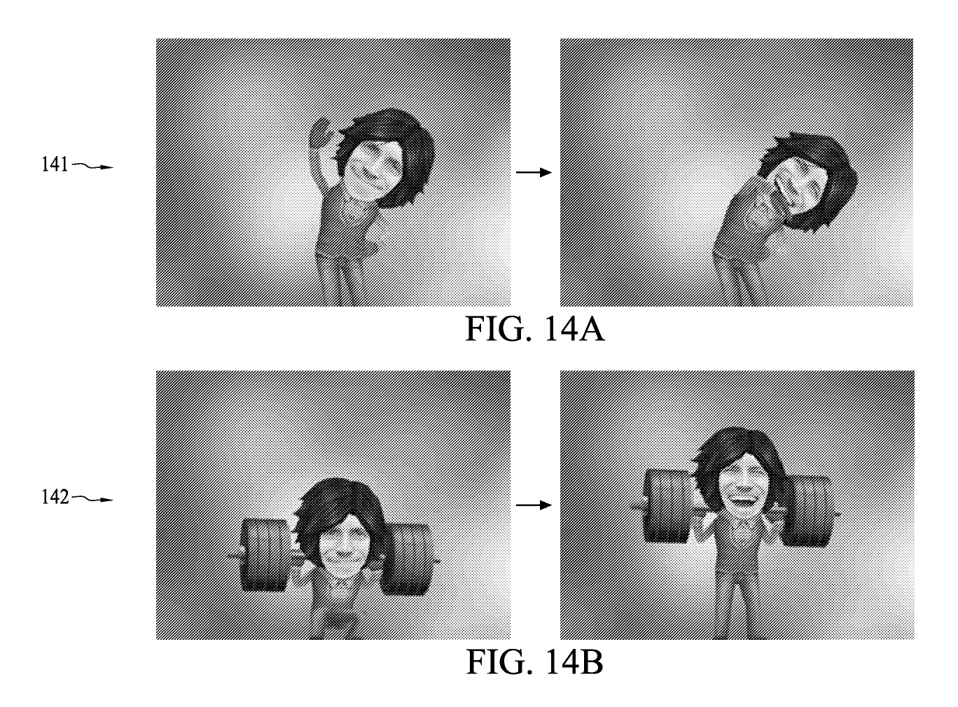

FIGS. 14A and 14B are diagrams illustrating an animated content in separate image frames at the instant messaging system, in accordance with some embodiments of the present disclosure. Referring to FIG. 14A, message 141 shows that Romeo is doing warm-up. Referring to FIG. 14B, message 142 shows that Romeo is doing weightlifting. Each of the messages 141 and 142 can be separately sent, independent of each other. In some embodiments, nevertheless, messages 141 and 142 are combined into a single message to tell a more complete story: Romeo is doing exercise. Accordingly, the message 141, now a sub-message of the combined message, contributes to a first part of the story, while the message 142, now another sub-message of the combined message, contributes to a second part of the story.

In some embodiments, a third sub-message can join the first and second sub-messages to render a more complicated story. In an embodiment, a new character can be introduced, or an old character can be removed in a sub-message.

In some embodiments, a different background environment can be selected by a user in a sub-message. In still some embodiments, a new textual input can be entered by a user in a sub-message. In yet still some embodiments, a message that integrates more than one sub-messages has a predetermined display time, for example, 18 seconds.

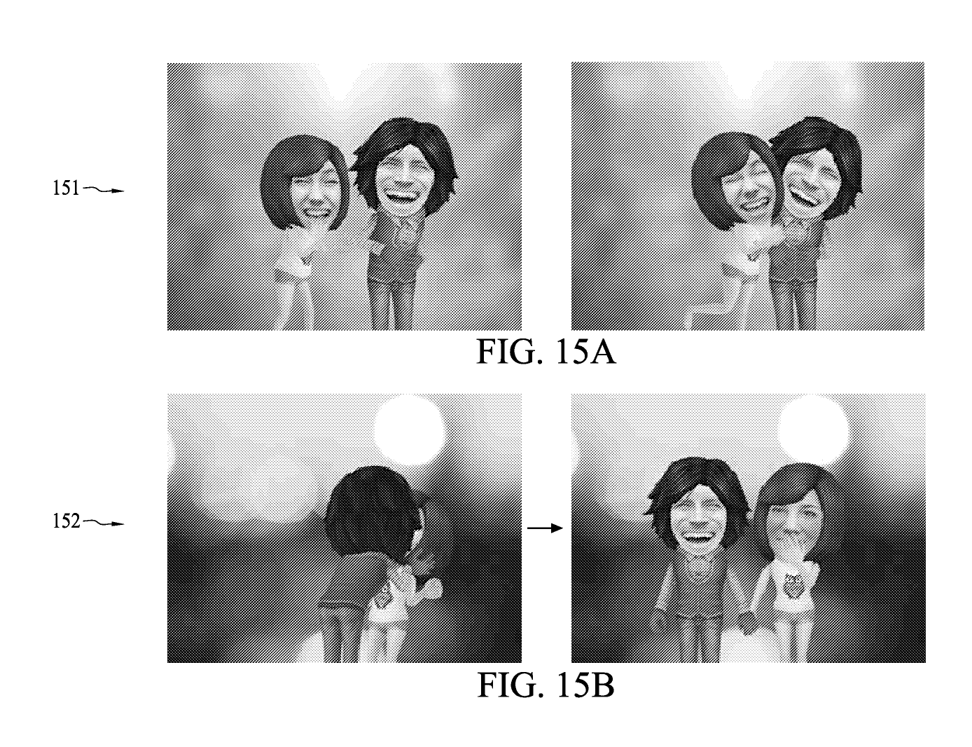

FIGS. 15A and 15B are diagrams illustrating an animated content in separate image frames at the instant messaging system, in accordance with some embodiments of the present disclosure. Referring to FIG. 15A, message 151 shows that Romeo and Juliet are chatting in a first background environment. Referring to FIG. 15B, message 152 shows that Romeo kisses Juliet in a second background environment. Similarly, each of the messages 151 and 122 can be separately sent, independent of each other. Nevertheless, messages 151 and 152 are combined into a single message to tell a more complete story: Romeo and Juliet are dating. The message 151, now a sub-message of the combined message, contributes to a first part of the story, while the message 152, now another sub-message of the combined message, contributes to a second part of the story.

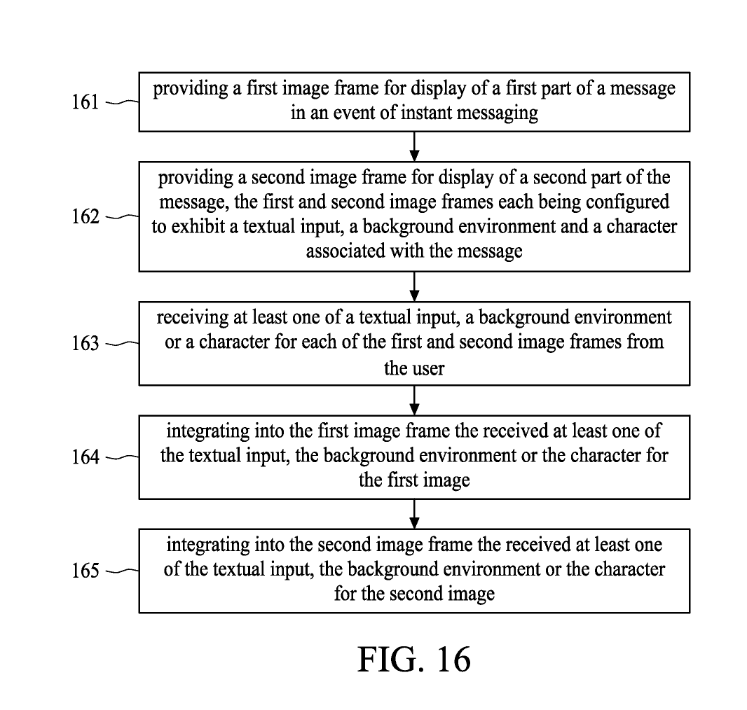

FIG. 16 is a flow diagram illustrating a method of instant messaging, in accordance with some embodiments of the present disclosure. The method facilitates a user in the instant messaging system to express his/her thought or emotion in a message in a story style. Referring to FIG. 16, in operation 161, a first image frame for display of a first part of a message in an event of instant messaging is provided.

In operation 162, a second image frame for display of a second part of the message is provided. The first and second image frames are each configured to exhibit a textual input, a background environment and a character associated with the message.

In operation 163, at least one of a textual input, a background environment or a character for each of the first and second image frames from the user is received.

In operation 164, the received at least one of the textual input, the background environment or the character for the first image frame is integrated into the first image frame.

In operation 165, the received at least one of the textual input, the background environment or the character for the second image frame is integrated into the second image frame. Subsequently, the first part of the message in the first image frame, and the second part of the message in the second image frame are combined, resulting in a story-based message.

Embodiments of the present disclosure provide a method of instant messaging. The method comprises providing an image frame for display of a message in an event of instant messaging, the image frame configured to exhibit a textual input, a background environment and a character associated with the message; receiving at least one of a textual input, a background environment or a character from a user; and integrating into the image frame the received at least one of the textual input, the background environment or the character.

In an embodiment, the operation of receiving includes receiving a still image of one of the at least one of the textual input, the background environment or the character.

In another embodiment, the operation of receiving includes receiving an animated content of one of the at least one of the textual input, the background environment or the character.

In still another embodiment, the animated content includes a change in at least one of font, size, color and orientation of the textual input.

In yet another embodiment, receiving a background environment includes providing a set of background environments selectable by the user; and receiving a selected background environment from the user.

In yet still another embodiment, receiving a character includes receiving a headshot photo from the user.

In another embodiment, the method further comprises changing a facial feature of the headshot photo.

In another embodiment, integrating into the image frame the received character includes providing a set of body figures selectable by the user; and integrating a selected torso and the headshot photo.

In still another embodiment, the method further comprises providing another character in at least one of the first image frame or the second image frame, the character performing an action on the other character.

In yet still another embodiment, the method further comprises exchanging the position of the characters, the other character performing the action on the character.

Some embodiments of the present disclosure provide a method of instant messaging. The method comprises providing a first image frame for display of a first part of a message in an event of instant messaging; providing a second image frame for display of a second part of the message, the first and second image frames each being configured to exhibit a textual input, a background environment and a character associated with the message; receiving at least one of a textual input, a background environment or a character for each of the first and second image frames from the user; integrating into the first image frame the received at least one of the textual input, the background environment or the character for the first image; and integrating into the second image frame the received at least one of the textual input, the background environment or the character for the second image.

In an embodiment, the operation of receiving includes receiving a still image of one of the at least one of the textual input, the background environment or the character.

In another embodiment, the operation of receiving includes receiving an animated content of one of the at least one of the textual input, the background environment or the character.

In still another embodiment, the method further comprises providing another character in at least one of the first image frame or the second image frame, the character performing an action on the other character.

In yet another embodiment, the method further comprises exchanging the position of the characters, the other character performing the action on the character.

Embodiments of the present disclosure also provide a system for instant messaging. The system comprises a memory, one or more processors and one or more programs stored in the memory and configured for execution by the one or more processors. The one or more programs include instructions for providing an image frame for display of a message in an event of instant messaging, the image frame configured to exhibit a textual input, a background environment and a character associated with the message, receiving at least one of a textual input, a background environment or a character from a user, and integrating into the image frame the received at least one of the textual input, the background environment or the character.

In an embodiment, the instruction for receiving includes receiving a still image of one of the at least one of the textual input, the background environment or the character.

In another embodiment, the instruction for receiving includes receiving an animated content of one of the at least one of the textual input, the background environment or the character.

In still another embodiment, the system further comprises instructions for providing another character in at least one of the first image frame or the second image frame, the character performing an action on the other character.

In yet another embodiment, the system further comprises instructions for exchanging the position of the characters, the other character performing the action on the character.

Some embodiments of the present disclosure provide a non-transitory computer readable storage medium storing one or more programs is provided. The one or more programs includes instructions, which when executed by a computing device, causes the computing device to perform the following operations. In one operation, an image frame for display of a message in an event of instant messaging is provided. The image frame is configured to exhibit a textual input, a background environment and a character associated with the message. In one operation, at least one of a textual input, a background environment or a character from a user is received. In one operation, the received at least one of the textual input, the background environment or the character is integrated into the image frame.

Although the present disclosure and its advantages have been described in detail, it should be understood that various changes, substitutions and alterations cancan be made herein without departing from the spirit and scope of the present disclosure as defined by the appended claims. For example, many of the processes discussed above cancan be implemented in different methodologies and replaced by other processes, or a combination thereof.

Moreover, the scope of the present application is not intended to be limited to the particular embodiments of the process, machine, means, methods and steps described in the specification. As one of ordinary skill in the art will readily appreciate from the disclosure of the present disclosure, processes, machines, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, means, methods, or steps.

What is claimed is:

1. A method of instant messaging, the method comprising:
providing an image frame for display of a message in an event of instant messaging, the image frame configured to exhibit a textual input, a background environment and a character associated with the message;
receiving at least one of a textual input, a background environment or a character from a user; and
integrating into the image frame the received at least one of the textual input, the background environment or the character.

2. The method according to claim 1, wherein the operation of receiving includes:
receiving a still image of one of the at least one of the textual input, the background environment or the character.

3. The method according to claim 1, wherein the operation of receiving includes:
receiving an animated content of one of the at least one of the textual input, the background environment or the character.

4. The method according to claim 3, wherein the animated content includes a change in at least one of font, size, color and orientation of the textual input.

5. The method according to claim 1, wherein receiving a background environment includes:
providing a set of background environments selectable by the user; and
receiving a selected background environment from the user.

6. The method according to claim 1, wherein receiving a character includes:
receiving a headshot photo from the user.

7. The method according to claim 6 further comprising:
changing a facial feature of the headshot photo.

8. The method according to claim 6, wherein integrating into the image frame the received character includes:
providing a set of body figures selectable by the user; and
integrating a selected body figure and the headshot photo.

9. The method according to claim 1 further comprising:
providing another character in at least one of the first image frame or the second image frame, the character performing an action on the other character.

10. The method according to claim 9 further comprising:
exchanging the position of the characters, the other character performing the action on the character.

11. A method of instant messaging, the method comprising:
providing a first image frame for display of a first part of a message in an event of instant messaging;
providing a second image frame for display of a second part of the message, the first and second image frames each being configured to exhibit a textual input, a background environment and a character associated with the message;
receiving at least one of a textual input, a background environment or a character for each of the first and second image frames from the user;
integrating into the first image frame the received at least one of the textual input, the background environment or the character for the first image; and
integrating into the second image frame the received at least one of the textual input, the background environment or the character for the second image.

12. The method according to claim 11, wherein the operation of receiving includes:
receiving a still image of one of the at least one of the textual input, the background environment or the character.

13. The method according to claim 11, wherein the operation of receiving includes:
receiving an animated content of one of the at least one of the textual input, the background environment or the character.

14. The method according to claim 11 further comprising:
providing another character in at least one of the first image frame or the second image frame, the character performing an action on the other character.

15. The method according to claim 14 further comprising:
exchanging the position of the characters, the other character performing the action on the character.

16. A system for instant messaging, the system comprising:
a memory;
one or more processors; and
one or more programs stored in the memory and configured for execution by the one or more processors, the one or more programs including instructions for:
providing an image frame for display of a message in an event of instant messaging, the image frame configured to exhibit a textual input, a background environment and a character associated with the message;
receiving at least one of a textual input, a background environment or a character from a user; and
integrating into the image frame the received at least one of the textual input, the background environment or the character.

17. The system according to claim 16, wherein the instruction for receiving includes:
receiving a still image of one of the at least one of the textual input, the background environment or the character.

18. The system according to claim 16, wherein the instruction for receiving includes:
receiving an animated content of one of the at least one of the textual input, the background environment or the character.

19. The system according to claim 16 further comprising instructions for:
providing another character in at least one of the first image frame or the second image frame, the character performing an action on the other character.

20. The system according to claim 19 further comprising instructions for:
exchanging the position of the characters, the other character performing the action on the character.
